(19) United States
(12) Patent Application Publication
(10) Pub. No.: US 2006/0024062 A1
(43) Pub. Date: Feb. 2, 2006

(54) Pre-compensation for modulator distortion in optical systems

(75) Inventors: Lukas G. Jakober, Ottawa (CA); Sandy Thomson, Ottawa (CA); Ruibin Jin, Kanata (CA); Eric Hall, Ottawa (CA); Paul MacDonald, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Nortel Networks Limited, St. Laurent (CA)

(21) Appl. No.: 10/900,522

(22) Filed: Jul. 28, 2004

(51) Int. Cl. H04B 10/12

(52) U.S. Cl. 398/141

(57) ABSTRACT

System, method, and computer program product for accessing values from a multi-port memory having a plurality of read ports, each value representing a modulator distortion compensation value associated with a modulator of an optical device, and processing an input signal using the accessed values to generate an output signal that compensates for modulator distortion.

### BACKGROUND

High-speed data communications require a high bandwidth channel. Optical fiber is one medium that provides high bandwidth. Optical systems send digital pulses at a high race, e.g., 10 Gb/s. Ideally, the pulses that are transmitted are received as sent at the other end of the optical pipe. However, optical modulators frequently display a non-linear performance characteristic. If left uncompensated, the effects of the non-linearity of the modulator can degrade signal quality significantly enough to cause lose or corruption of data sent along an optically based network.

### SUMMARY

According to an aspect of the invention a method includes providing a multi-port memory having a plurality of read ports. The multi-port memory stores modulator distortion compensation values associated with a modulator of an optical device. The method includes processing an input signal using the values in the multi-port memory to generate an output signal for transmission on the optical link.

Advantages of the invention may include one or more of the following. The use of an electronic modulator distortion compensation unit that pre-compensates for distortions generated by a modulator of an optical device eliminates the expense of fiber and optical equipment on the optical links. The electronic modulator distortion compensation module provides a software programmable solution than is highly flexible The use of a multi-port memory saves on die area and power of an integrated circuit as compared to the use of a single-port or dual-port memory. The use of multiple multi-port memories to process parallel sets of data advantageously provides for a high throughput of data in an efficient manner. The details of one or more examples are set forth in the accompanying drawings and the description below. Further features, aspects, and advantages of the invention will become apparent from the description, the drawings, and the claims.

### DESCRIPTION OF DRAWINGS

FIG. 1. is a block diagram of an optical fiber communication system.

FIG. 2 is block diagram of a transmit device of the system.

FIG. 3 is a diagram depicting functional units of a dispersion compensation filter grouped into quads.

FIG. 4 is a block diagram of a functional unit of a dispersion compensation filter.

### DETAILED DESCRIPTION

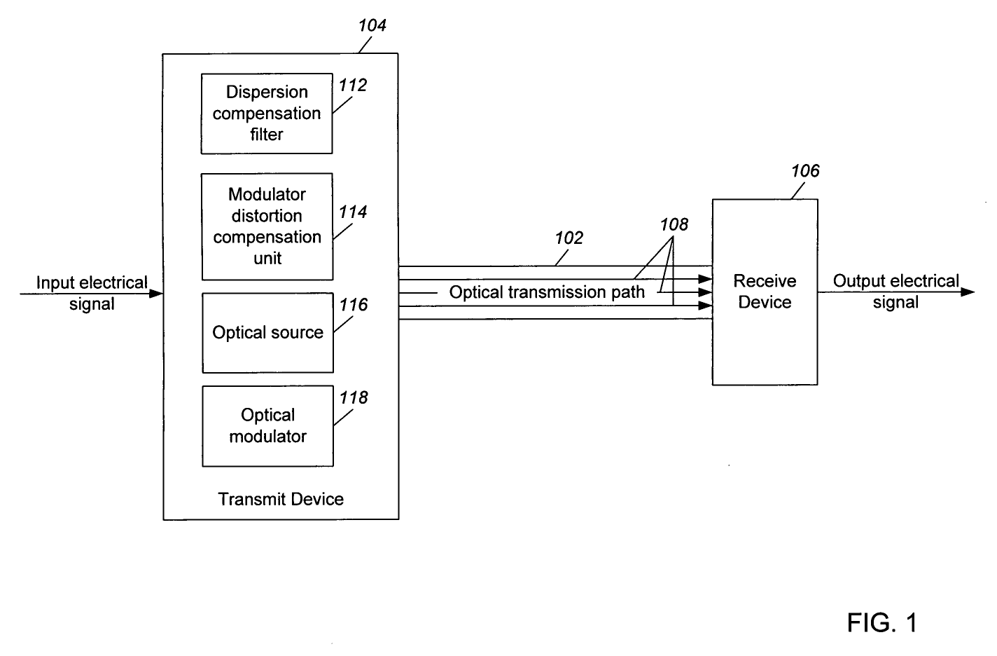

Referring to FIG. 1 an optical fiber communication system 100 is shown. The optical fiber communication system 100 includes an optical transmission path 102, a transmit device 104, and a receive device 106. The optical transmission path 102 includes one or more optical links 108, such as a fiber optic cable.

The transmit device 104 receives an input electrical signal from a source (e.g., a SFI-4 (SERDES to Framer Interface, Level 4) input interface for an OC-192 or G.709 transmit data stream) and passes the input electrical signal to a dispersion compensation filter 112. The dispersion compensation filter 112 filters the input electrical signal using a complex dispersion compensation impulse response c_{D}(t) to generate a dispersion-compensated electrical signal. A modulator distortion compensation unit 114 receives the dispersion-compensated electrical signal and uses a modulator compensation function c_{M}(t) co process the input electrical signal and generate a pre-distorted input electrical signal. The pre-distorted input electrical signal is converted to a corresponding pre-distorted optical signal by an electrical-to-optical converter (e.g., an optical source 116 coupled to an optical modulator 118) and transmitted to the receive device 106 over the optical transmission path 102. The receive device 106 includes an optical-to-electrical converter chat detects the optical signal received over the optical transmission path 102 and generates a corresponding output electrical signal.

The dispersion compensation filter 112 compensates for chromatic dispersion effects in the optical transmission path 102, while the modulator distortion compensation unit 114 compensates for distortions produced by the non-linear performance characteristics of the optical modulator. By compensating for both dispersion and modulator distortion, the output electrical signal generated by the receive device 106 is nominally equivalent to the input electrical signal received by the transmit device 104.

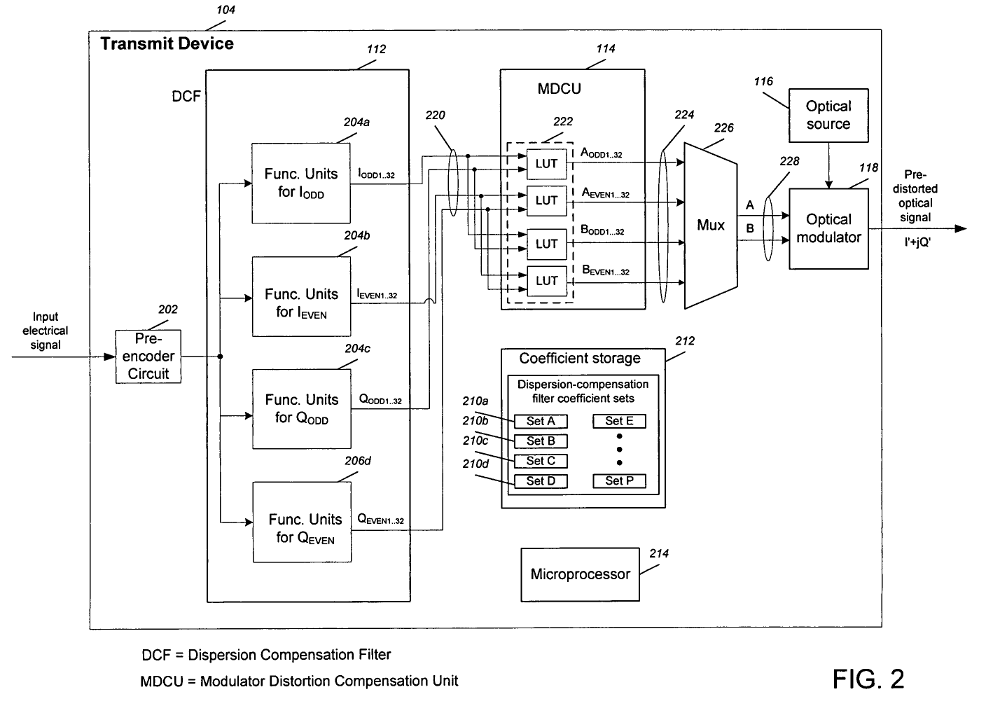

Referring to FIG. 2, an example of the transmit device 104 is shown. The transmit device 104 includes a pre-encoder circuit 202 that receives an input electrical signal, samples the input electrical signal, and generates an input data scream that is provided to the dispersion compensation filter 112. Generally, the dispersion compensation filter 112 represents a minimum amount of dispersion compensation, based on the derived compensation impulse response c_{D}(t), that has to be provided for the system 100 to achieve optimal performance.

Conceptually, the dispersion compensation filter 112 operates on the input data stream using two high-speed filters to generate two distinct output data streams: one 6-bit I (real) output data streams and one 6-bit Q (imaginary) output data scream. In the example of FIG. 2, the dispersion compensation filter 112 is a 76-tap Finite Impulse Response (FIR) filter implemented using 128 parallel low-speed filters that operate on shifted versions of the input data stream to generate 64 complex output data samples per clock cycle. The 128 parallel low-speed filters (“functional units”) include 64 functional units for generating the real part of the complex output data samples, and 64 functional units for generating the imaginary part of the complex output data samples.

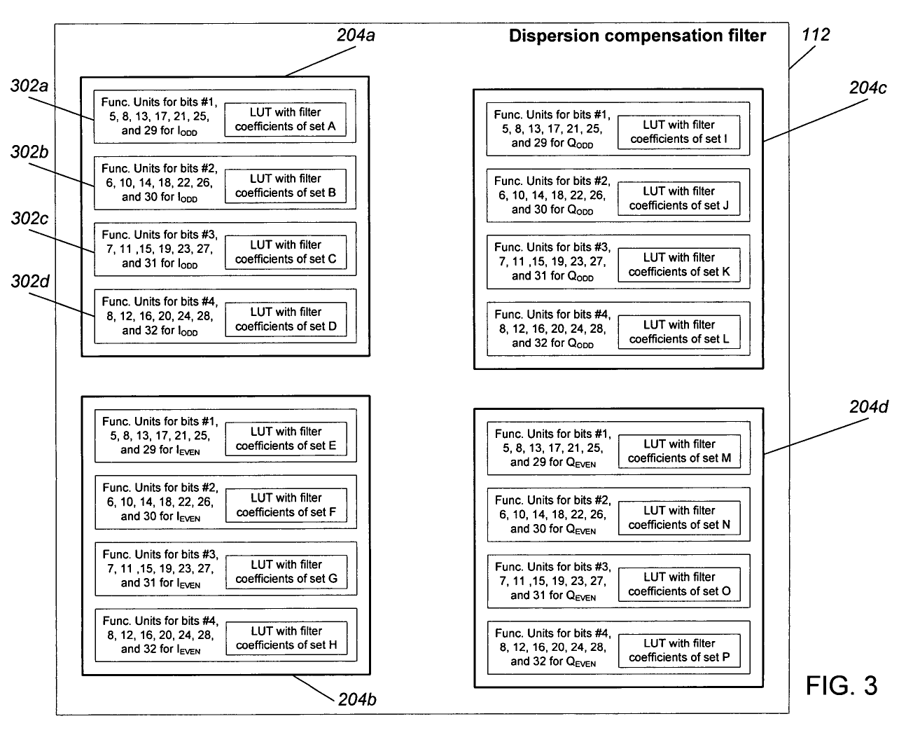

Referring also to FIG. 3, in one implementation, to provide for qudarature phase encoding, the 128 functional units are organized as follows: 32 functional units are used to generate the I_{ODDn} output data samples (shown conceptually in a box labeled 204a); 32 functional units are used to generate the I_{EVENn} output data samples (shown conceptually in a box labeled 204b); 32 functional units are used to generate the Q_{ODDn} output data samples (shown conceptually in a box labeled 204c); 32 functional units are used to generate the Q_{EVENn} output data samples (shown conceptually in a box labeled 204d), where n=1,2, . . . 32. Each set of 32 functional units is further grouped into 4 quads of 8 functional units each. For example, the 32 functional units 204a that are used to generate the I_{ODDn} output data samples are grouped into 4 quads 302a-302d. Each quad 302a-302d has a different set of filter coefficients drawn from sets of filter coefficients (e.g., set A 210a, set B 210b, set C 210c, and set D 210d) stored in a filter coefficient storage 212 in the transmit device 104; the 8 functional units of a quad share the same filter coefficients. The dispersion compensation filter 112 is configured to multiplex the outputs of the 128 functional units such that each of four consecutive odd (even) output samples is provided by a different quad.

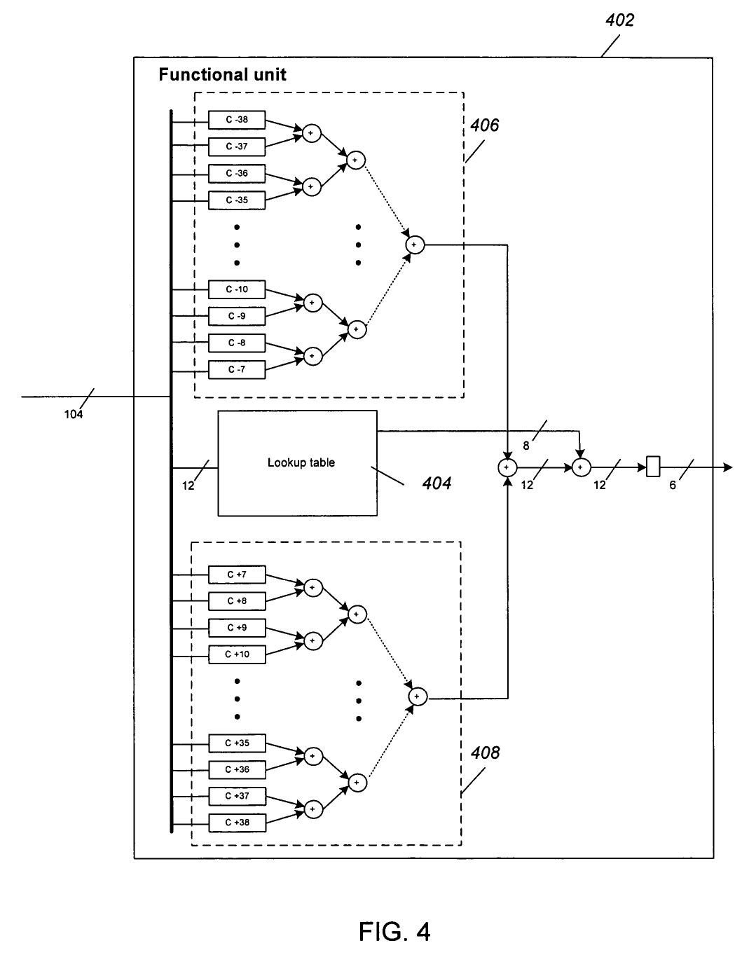

FIG. 4 shows an example of the functional unit 402 (e.g., one of the functional units in the box labeled 204a) used to generate the output data sample I_{ODD1} in detail. The functional unit 402 is implemented with a lookup table 404 and two adder trees 406, 408. To compute the output data sample I_{ODD1} based on the input data stream, the functional unit 402 operates on a 76-sample observation window of data. In the nomenclature used below, bits are referenced as positive or negative counting numbers. That is, the nomenclature does not use a bit zero. Other nomenclatures may be used. The 32 ‘newest’ data samples, e.g., samples +38 to +7, and the 32 ‘oldest’ data samples, e-g., samples −7 to −38, of the 76-bit sample window are fed to their corresponding linear adder trees 406, 408 to conjointly generate a 12-bit string representing a linear component of a final functional unit output.

The central 12 samples, e.g., samples −6 to +6, of the 76-sample window form an address (i.e. sample +6 represents the least significant bit and sample −6 the most significant bit of the address) to the lookup table 404 of the functional unit 402. The lookup table 404 stores dispersion compensation values that are pre-calculated output values of the compensation impulse response C_{D}(t) based on a number of input values. The functional unit 402 performs a lookup operation of the lookup cable 404 and retrieves an 8-bit value corresponding with the address. The retrieved 8-bit value represents a non-linear component of the final functional unit output. The functional unit 402 adds the retrieved 8-bit value to the 12-bit string generated by the linear adder trees and generates a 12-bit string representing a high resolution functional unit output. In one implementation, the functional unit 402 scales and clips the high resolution functional unit output to generate a 6-bit string representing the output data sample I_{ODD1}.

The 76-sample observation window of data operated on by the functional unit 204a is simultaneously (i.e., in the same clock cycle) operated on by the functional unit 204c used to generate the output data sample Q_{ODD1}.

To compute the next output data sample (i.e., I_{EVEN1} and Q_{EVEN1}), the 76-sample observation window is shifted by 1 sample with respect to the previous window and the sample values are provided to the respective functional units 204b, 204d used for generating the output data samples I_{EVEN1} and Q_{EVEN1}.

The output data samples generated by the dispersion compensation filter 112 collectively represent the I and Q components of a dispersion-compensated electrical signal 220. The complex dispersion-compensated electrical signal 220 is provided to the modulator distortion compensation unit 114 as input data.

The modulator distortion compensation unit 114 processes the dispersion-compensated electrical signal to produce a non-linearly pre-compensated electrical signal which is used to drive the optical modulator 118. The non-linear performance characteristics of an optical modulator are typically well characterized. Accordingly, a modulator compensation function c_{N}ⁿ(x₁,x₂, . . . ,x_{N}), where n-1,2, . . . ,N can be derived for a N-dimensional non-linear optical modulator and applied to a signal to prevent signal distortion and consequential data corruption.

Modulator compensation functions are highly dependent on the type of optical modulators used in (or by) the transmit device 104. In general, for a N-dimensional optical modulator, N compensation functions are required. Each compensation function includes N inputs (x₁,x₂, . . . ,x_{N}) and 1 non-linearly dependent output yₙ. To reduce complexity and to optimize hardware speed, it is convenient to pre-calculate the output values of each compensation function for a limited number of combinations of input values and to store the results in N lookup tables.

In the examples of FIGS. 1 and 2, the transmit device 104 is implemented with a two-dimensional optical modulator in order to support dispersion compensation. Two modulator compensation functions are derived and the corresponding two lookup tables (C_{M}¹(x₁,x₂) and c_{M}²(x₁,x₂)) are generated. Each lookup table has two inputs and one output. The two input x₁ and x₂ of the lookup tables (C_{M}¹(x₁,x₂) and c_{M}²(x₁,x₂)) correspond to the real (x₁=I) and imaginary part (x₂=Q) of the complex electrical input signal. The output of the lookup table (cM^{t}(x₁,x₂)) is y₁=A, and the output of the lookup table (C_{M}²(x₁,x₂)) is y₂=B. A and 8 are the non-linearly pre-compensated electrical signals which drive the two inputs of the optical modulator 118.

In one example, the lookup tables (c_{M}¹(x₁,x₂) and c_{M}²(x₁,x₂)) 222 are implemented using multiple multi-port RAMS 222. Using multi-port RAMs 222 significantly reduces the number of lookup tables required in a system where a large number, in this case 64 complex electrical samples are processed in parallel. Instead of 64 copies of the lookup cables (c_{M}¹(x₁,x₂) and 64 c_{M}²(x₁,x₂)), the number of copies of the lookup tables (C_{M}¹(x₁, x₂) and c_{M}²(x₁,x₂)) can be reduced by a factor equal to the number of read ports. e.g. to 8 c_{M}¹(x₁,x₂) and a c_{M}²(x₁,x₂) copies if 9-port RAMS, which feature 8 read ports, are used.

Each read port provides a 12-bit address interface which is shared by the I and Q parts of the input electrical signal. For example, a 12-bit address can be formed by concatenating 6 bits front the I signal path and 6 bits from the Q signal path. The modulator distortion compensation unit 114 performs a lookup operation of a lookup table and retrieves an 8-bit value corresponding to this address. Each retrieved 8-bit value represents a modulator distortion compensation value associated with a distortion in the magnitude or phase of a signal modulated by the optical modulator 118 which in this example, is a 2-dimensional optical modulator) in the system 100. The retrieved 8-bit values collectively represent A and B components of the pre-distorted input electrical signal 224 that compensates for both dispersion and modulator distortion.

The pre-distorted input electrical signal 224 is provided to a multiplexer 226 that passes the resulting A and a components of the pre-distorted input electrical signal 228 to the optical modulator 118. The optical modulator 118 modulates the magnitude and phase of the light generated by the optical source 116 in response to the A and B components of the pre-distorted input electrical signal 228 and converts the pre-distorted input electrical signal into a corresponding optical signal with real part I′ and imaginary part Q′. The optical signal is transmitted to the receive device 106 over the optical transmission path 102. Various methods can be used to derive the compensation functions c_{D}(t) and c_{M}(t) deterministically and/or adaptively, using known techniques. In one example shown in FIG. 2, the transmit device 104 can include a microprocessor 214 that is configured to receive data relating to dispersion, length, temperature and time effects of each optical link 108 (or span of optical link 108) in the optical transmission path 102, and derive a compensation function c_{D}(t) that may be applied to an optical signal to compensate for the dispersion effects in a corresponding optical link 108. The microprocessor 214 may be further configured to employ far end feedback, e.g., bit error rate and frame alignment word error rate, to dynamically fine tune the dispersion compensation values in order to optimize the performance of the optical link 18.

In one implementation, the 9-port RAMS 222 operate in either “micro” mode or “datapath” mode. The 9-port RAMS 222 operate in memory space pairs, e.g., memory space 1 and memory space 2, where only one memory space is active in datapath mode. When the 9-port RAMS 222 are in micro mode, the coefficients in each read port may be updated by the microprocessor 214. When the 9-port RAMS 222 are in datapath mode, the memory addresses are the values of the data in the data path, and any attempted writes will not occur. In this manner, the coefficient updates of the 9-port RAMS 222 may be performed without causing any discontinuity in the processing of the input data stream. That is, the coefficient update is a synchronous operation in which the 9-port RAMs 222 switch between memory space 1 and memory space 2 on consecutive clock cycles.

The examples of FIG. 1-5 have been described in terms of a transmit device implemented with a two-dimensional optical modulator. In other examples, the transmit device includes a single-dimensional optical modulator for modulating either the magnitude or the phase of the light generated by an optical source in response to a non-complex modulator distortion-compensated input electrical signal. In another example, a dispersion compensation filter can be provided in the receive device 106, and/or in separate devices located along the optical transmission path 102, rather than in che transmit device 102 as shown in FIG. 1.

The systems described herein can be implemented in digital electronic circuitry, in computer hardware, or in combinations of them. The systems described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one sire or distributed across multiple sires and interconnected by a communication network.

Particular embodiments have been described, however other embodiments are within the scope of the following claims.

What is claimed is:

1. A method comprising:
accessing values from a multi-port memory having a plurality of read ports, each value representing a modulator distortion compensation value associated with a modulator of an optical device; and
processing an input signal using the accessed values to generate an output signal that compensates for modulator distortion.

2. The method of claim 1, wherein the multi-port memory is a nine-port memory having eight read ports.

3. The method of claim 1, wherein processing the input signal comprises:
receiving an input electrical signal;
sampling the input electrical signal to provide an input data stream; and
applying the accessed values to the input data stream to generate one or more output data streams.

4. The method of claim 1, wherein applying the values to the input data stream comprises:
identifying a first portion of the input data stream as an address to the multi-port memory; and
retrieving a value from the multi-port memory using the address.

5. An electrical device coupled to a N-dimensional modulator, the electrical device comprising:
a compensation unit including a multi-port memory storing N lookup tables of modulator distortion compensation values, the unit operative to:
access the values of the N lookup tables using an input signal; and
generate an output signal that compensates for modulator distortion associated with the N-dimensional modulator.

6. The electrical device of claim 5, wherein the multi-port memory is a nine-port memory having eight read ports.

7. A system comprising:
an optical transmission path having one or more optical links;
a transmit device including a compensation unit, the compensation unit including a multi-port memory storing N lookup tables of modulator distortion compensation values associated with a N-dimensional modulator of the system; and
a receive device coupled to the transmit device by the optical transmission path,
the compensation unit to access the value of the N lookup tables using an input signal and generate an output signal that compensates for modulator distortion associated with the N-dimensional modulator.

8. The system of claim 7, wherein the multi-port memory is a nine-port memory having eight read ports.

9. The system of claim 7, wherein the transmit device further comprises:
a pre-encoder circuit to receive an input electrical signal, sample the input electrical signal and generate an input data stream.

10. The system of claim 7, wherein the transmit device further comprises:
a dispersion compensation filter to receive the input data stream from the pre-encoder circuit, process the input data stream and generate a dispersion-compensated signal.

11. The system of claim 10, wherein the compensation unit receives the dispersion-compensated signal, uses the dispersion-compensated signal to access the N lookup tables, and generates a pre-distorted electrical signal that compensates for dispersion and modulator distortion.

12. A computer program product, tangibly embodied in an information carrier, the computer program product being operable to cause a machine to:
access values from a multi-port memory having a plurality of read ports, each value representing a modulator distortion compensation value associated with a modulator of an optical device; and
process an input signal using the accessed values to generate an output signal that compensate for modulator distortion.

13. The computer program product of claim 12, wherein the multi-port memory is a nine-port memory having eight read ports.

14. The computer program product of claim 12 being further operable to cause a machine to:
receive an input electrical signal;
sample the input electrical signal to provide an input data stream; and
apply the accessed values to the input data stream to generate one or more output data streams.

15. The computer program product of claim 12 being further operable to cause a machine to:
identify a first portion of the input data stream as an address to the multi-port memory; and
retrieve a value from the multi-port memory using the address.
